(19) United States
(12) Patent Application Publication
(10) Pub. No.: US 2006/0035804 A1
(43) Pub. Date: Feb. 16, 2006

(54) Use of cellulose derivatives as foam regulators

(76) Inventors: Josef Penninger, Hilden (DE); Erik Bruckner, Hilden (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/201,260

(22) Filed: Aug. 10, 2005

Related U.S. Application Data
(63) Continuation of application No. PCT/EP04/00873, filed on Jan. 31, 2004.

(30) Foreign Application Priority Data
Feb. 10, 2003 (DE) DE 103 05 306.9
Oct. 31, 2003 (DE) DE 103 51 266.7

(51) Int. Cl. C11D 3/22

(52) U.S. Cl. 510/473

(57) ABSTRACT

Cellulose derivatives, obtained by the alkylation and hydroxyalkylation of cellulose, which contribute to a reduction of the foaming properties of cleaning agents or detergents when used in aqueous cleaning or detergent solutions.

### CROSS-REFERENCE TO RELATED APPLICATIONS

This application is a continuation under § 365(c) and 35 U.S.C. § 120 of international application PCT/EP2004/000873, filed Jan. 31, 2004. This application also claims priority under 35 U.S.C. § 119 of DE 103 05 306.9, filed Feb. 10, 2003 and of DE 10351 266.7, filed Oct. 31, 2003, both of which are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION.

(1) Field of the Invention

The invention relates to the use of certain cellulose derivatives as foam regulators in laundry detergents or cleaning compositions, and to a pourable and free-flowing, particulate foam inhibiting composition comprising water-soluble or water-dispersible support material and cellulose derivative adsorbed thereon.

In aqueous cleaning liquors, as occur in customary washing treatment in washing machines, especially in domestic drum washing machines, the regulation of foam development is indispensable, since neither excessive foaming nor the complete absence of foam is conducive to the desired washing success. There has therefore been no shortage of proposals to solve the problem of excessive foam development of laundry detergents. Based on the use amount required, the most effective foam regulators known to date have been the silicone defoamers which consist of generally liquid polysiloxanes having alkyl or aryl substituents and finely divided silica. However, polysiloxanes with known good defoamer action are comparatively costly and inconvenient in their preparation and possess the disadvantage that they have often been perceived, especially in recent times, not to be fully satisfactory in their biodegradability. Silicone-free foam regulating compositions are also known. For example, the European patent EP 87 233 discloses a process for producing a low-foaming laundry detergent, in which mixtures of an oily or waxy substance and bisamides are applied to a support powder, in particular a spray-dried surfactant-containing laundry detergent. The oily or waxy substance can, for example, consist of Vaseline having a melting point of from 20° C. to 120° C. In this type of processing, specifically the spraying of the composition onto the spray-dried, surfactant-containing laundry detergent, the risk exists that the production process has a disadvantageous effect on the storage stability of the foam regulating component, with the result that its activity decreases with increasing storage time. In order to increase their action and simultaneously to lower the required use concentration, further foam inhibitors are frequently added to these defoamers, in particular the known polysiloxanes or polysiloxane-silica mixtures. Further foam-regulating laundry detergents are known from the European patents EP 75 433 and EP 94 250. However, foam regulating compositions described there likewise comprise silicones and cannot be considered for the reasons mentioned. The German laid-open specification DT 28 57 155 discloses laundry detergents having a foam regulating composition which comprises hydrophobic silicon dioxide and a mixture of solid and liquid hydrocarbons, optionally in a mixture with fatty acid esters. The high content of hydrocarbon liquid at room temperature of from 22.5% by weight to about 98% by weight results in the risk of clumping in the case of such foam regulating compositions. The German laid-open specification DE 34 00 008 discloses foam regulating compositions comprising paraffin wax mixtures and hydrophobized silica, optionally in combination with branched-chain alcohols. Pulverulent defoamers which comprise a liquid mixture of high molecular weight, branched-chain alcohols with hydrophobized silica in combination with a water-insoluble wax on a water-soluble pulverulent support are known from the German laid-open specification DE 31 15 644. The European patent EP 0 309 931 describes foam regulating compositions which comprise a relatively complicated mixture of paraffin wax and microcrystalline paraffin wax.

In low-temperature machine washing which has become ever more important in recent times, such compositions in some cases have defoamer performance which is perceived to be inadequate and cannot always be incorporated satisfactorily in a storage-stable manner into pulverulent laundry detergents or cleaning compositions. Moreover, both silicones and paraffins are comparable with regard to the cleaning performance required for oily stains in the washing process; they should therefore only be present in minimum amounts in the laundry detergent or cleaning composition, so that they do not lead to an impairment of the action of the laundry detergent or cleaning composition ingredients needed for the removal of stains.

It is accordingly an object of the invention to provide a foam regulator which can be formulated in the form of a free-flowing foam regulating composition and, when used in laundry detergents and cleaning compositions, is effective over a wide temperature range, i.e. suppresses troublesome foam development in the cold washing range, at moderate washing temperatures and also in the boiling washing range. Furthermore, both the foam regulator and the foam regulating composition comprising it should be storage- and action-stable in a mixture with customary laundry detergent constituents and not exert any disadvantageous effects on the material treated and the environment.

It has been found that, surprisingly, this problem can be solved by certain cellulose derivatives.

The present invention thus provides for the use of cellulose derivatives which are obtainable by alkylation and hydroxyalkylation of cellulose for reducing foaming of laundry detergents or cleaning compositions when they are used in aqueous washing or cleaning solutions.

### BRIEF DESCRIPTION OF THE SEVERAL VIEWS OF THE DRAWING(S)

Not Applicable

### DETAILED DESCRIPTION OF THE INVENTION

Preferred cellulose derivatives are those which have been alkylated with C₁ to C₁₀ groups, in particular C₁ to C₃ groups, and additionally bear C₂ to C₁₀ hydroxyalkyl groups, in particular C₂ to C₃ hydroxyalkyl groups. These can be obtained in a known manner by reacting cellulose with appropriate alkylating agents, for example alkyl halides or alkyl sulfates, and subsequent reaction with appropriate alkylene oxides, for example ethylene oxide and/or propylene oxide. In a preferred embodiment of the invention, the cellulose derivative contains on average from 0.5 to 2.5, in particular from 1 to 2, alkyl groups, and from 0.02 to 0.5, in particular from 0.05 to 0.3, hydroxyalkyl group per anhydroglycose monomer unit. The average molar mass of the cellulose derivatives used in accordance with the invention is preferably in the range from 10 000 D to 150 000 D, in particular from 40 000 D to 120 000 D and more preferably in the range from 80 000 D to 110 000 D. The determination of the degree of polymerization and of the molecular weight of the soil release-capable cellulose derivative is based on the determination of the limiting viscosity number on sufficiently dilute aqueous solutions by means of a Ubbelohde capillary viscometer (Oc capillary). Using a constant [H. Staudinger and F. Reinecke, “Über Molekulargewichtsbestimmung an Celluloseethern” [on molecular weight determination of cellulose ethers], Liebigs Annalen der Chemie 535, 47 (1938) and a correction factor [F. Rodriquez and L. A. Goettler, “The flow of Moderately Concentrated Polymer Solutions in Water”, Transactions of the Society of Rheology VIII, 3 17 (1964) it is possible to calculate therefrom the degree of polymerization and, with incorporation of the degrees of substitution (DS and MS), the corresponding molecular weight.

Such cellulose derivatives possess soil release capability, so that they do not impair the performance of laundry detergents or cleaning compositions, but rather, on the contrary, additionally contribute to the washing or cleaning result as well as their foam-regulating action.

When said cellulose derivatives are used as foam inhibitors in machine washing of textiles, it has also been observed, especially when very foam-intensive surfactants, for example branched-chain nonionic surfactants, are used, that a reduction in the foam is achieved not only in the actual washing cycle of machine washing processes, but also in the rinse cycles, into which foam can be entrained, so that foam residues possibly even remain on the washed material. The invention therefore further relates to the use of cellulose derivatives which are obtainable by alkylation and hydroxyalkylation of cellulose for reducing the foam in the rinse cycles in the machine washing of textiles.

The invention finally provides a particulate, free-flowing foam regulating composition containing from 0.5% by weight to 30% by weight of a cellulose derivative to be used in accordance with the invention adsorbed on from 70% by weight to 99.5% by weight of a water-soluble or water-dispersible, inorganic and/or organic support material.

The preferably phosphate-free support material has a particulate structure and consists of water-soluble or water-dispersible compounds, primarily of inorganic and/or organic salts, which are suitable for use in laundry detergents and cleaning compositions. The water-soluble inorganic support materials include in particular alkali metal carbonate, alkali metal borate, alkali metal aluminosilicate and/or alkali metal sulfate, optionally with additives of alkali metal silicate, the latter being able to contribute to good grain stabilities of the inventive compositions. The alkali metal silicate is preferably a compound having a molar ratio of alkali metal oxide to SiO₂ of from 1:1.5 to 1:3.5. The use of such silicates results in particularly good grain properties, in particular high attrition stability and nevertheless high dissolution rate in water. The additionally usable inorganic materials include in particular zeolites and sheet silicates, for example bentonite. The zeolites which can be used in the support material for the inventive foam regulating compositions include in particular zeolite A, zeolite P and zeolite X.

Useful organic support materials are, for example, acetates, tartrates, succinates, citrates, carboxymethylsuccinates and the alkali metal salts of aminopolycarboxylic acids, such as EDTA, hydroxyalkanephosphonates and aminoalkanepolyphosphonates, such as 1-hydroxyethane-1,1-diphosphonate, ethylenediaminotetramethylenephosphonate and diethylenetriaminepentamethylenephosphonate. Also usable are water-soluble salts of polymeric or copolymeric carboxylic acids, for example copolymers of acrylic acid and maleic acid, and also the polycarboxylic acids which are known, for example, from the international patent application WO 93/08251 and are obtained by oxidation of polysaccharides. The preferred alkali metal in the alkali metal salts mentioned is sodium in all cases. It is also possible to use organic substances not present in salt form, for example starch or starch hydrolyzates, as support material components. Mixtures of inorganic and organic salts may be used advantageously in many cases.

The support material may additionally comprise film-forming polymers, for example polyethylene glycols, polyvinyl alcohols, polyvinylpyrrolidones, polyacrylates and cellulose ethers not corresponding to the cellulose derivatives essential to the invention, in particular alkali metal carboxymethylcellulose, methylcellulose, ethylcellulose, hydroxyethylcellulose, and mixtures thereof. Preference is given to using mixtures of sodium carboxymethylcellulose and methylcellulose, where the carboxymethylcellulose typically has a degree of substitution of from 0.5 to 0.8 carboxymethyl group per anhydroglycose unit, and the methylcellulose has a degree of substitution of from 1.2 to 2 methyl groups per anhydroglycose unit. The mixtures preferably comprise alkali metal carboxymethylcellulose and nonionic cellulose ethers in weight ratios of from 80:20 to 40:60, in particular from 75:25 to 50:50. Such cellulose ether mixtures may be used in solid form or as aqueous solutions, which may be preswollen in a customary manner. Such film-forming polymers are present in the support material preferably not to an extent of more than 5% by weight, in particular from 0.5% by weight to 2% by weight, based on overall support material.

The support material component of the inventive foam regulating composition contains, in a preferred embodiment, up to 99% by weight, in particular from 60% by weight to 95% by weight, of alkali metal carbonate and/or alkali metal sulfate, in particular sodium carbonate and/or sodium sulfate, up to 35% by weight, in particular from 0.5% by weight to 30% by weight, of alkali metal silicate, in particular sodium silicate, and up to 5% by weight, in particular from 0.5% by weight to 2% by weight, of water-soluble or water-swellable polymer, in particular anionic cellulose ethers.

In addition to the cellulose derivative used in accordance with the invention, it is also possible in all aspects of the invention to use customary foam regulators which include, for example, long-chain soaps, in particular behenic soap, fatty acid amides, paraffins, waxes, microcrystalline waxes, organopolysiloxanes and mixtures thereof, which may additionally comprise microfine, optionally silanized or otherwise hydrophobized silica. For use in particulate compositions, such foam inhibitors are preferably bound to granular, water-soluble support substances, as described, for example, in the German laid-open specification DE 34 36 194, the European patent applications EP 262 588, EP 301 414, EP 309 931, or the European patent EP 150 386. The cellulose derivative to be used in accordance with the invention can be incorporated into the particles known from the documents mentioned.

Preference is given to an additional paraffin-based defoamer mixture which contains (a) from 70% by weight to 95% by weight of a paraffin wax or a paraffin wax mixture and (b) from 5% by weight to 30% by weight of a bisamide derived from C₂₋₇ diamines and saturated C₁₂₋₂₂ carboxylic acids. Especially in the case of silicone and paraffin foam regulators, it has been found that their defoamer action can be further enhanced by the use of the cellulose derivatives mentioned.

The paraffin wax (component a) present in the optionally present additional preferred defoamer mixture generally constitutes a complex substance mixture without a sharp melting point. For characterization, its melting range is typically determined by differential thermal analysis (DTA), as described in “The Analyst” 87 (1962), 420, and/or its solidification point. This refers to the temperature at which the wax is converted by slow cooling from the liquid into the solid state. Paraffins having fewer than 17 carbon atoms cannot be used in accordance with the invention; their fraction in the paraffin wax mixture should therefore be as low as possible and is preferably below the limit of significantly measurable by the customary analytical methods, for example gas chromatography. Preference is given to using waxes which solidify in the range from 20° C. to 70° C. It should be noted that even paraffin wax mixtures which appear to be solid at room temperature can comprise variable fractions of liquid paraffin. In the case of the paraffin waxes usable in accordance with the invention, the liquid fraction at 40° C. is at a maximum without already being 100% at this temperature. Preferred paraffin wax mixtures have a liquid fraction at 40° C. from at least 50% by weight, in particular from 55% by weight to 80% by weight, and a liquid fraction of at least 90% by weight at 60° C. This has the consequence that the paraffins are free-flowing and pumpable at temperatures down to at least 70° C., preferably down to at least 60° C. It should also be ensured that the paraffins comprise very low volatile fractions. Preferred paraffin waxes contain less than 1% by weight, in particular less than 0.5% by weight, of fractions evaporable at 110° C. and standard pressure. Paraffin waxes usable in accordance with the invention can be purchased, for example, under the trade names Lunaflex® from Fuller and Deawax® from DEA Mineralöl AG.

Component (b) of said optional additional defoamer mixture consists of bisamides which derive from saturated fatty acids having from 12 to 22, preferably from 14 to 18, carbon atoms, and from alkylenediamines having from 2 to 7 carbon atoms. Suitable fatty acids are lauric acid, myristic acid, stearic acid, arachic acid and behenic acid, and also mixtures thereof, as are obtainable from natural fats or hydrogenated oils such as tallow or hydrogenated palm oil. Suitable diamines are, for example, ethylenediamine, 1,3-propylenediamine, tetramethylenediamine, pentamethylenediamine, hexamethylenediamine, p-phenylenediamine and toluenediamine. Preferred diamines are ethylenediamine and hexamethylenediamine. Particularly preferred bisamides are bismyristoylethylenediamine, bispalmitoylethylenediamine, bisstearoylethylenediamine and mixtures thereof, and also the corresponding derivatives of hexamethylenediamine. As described in the European patent application EP 309 931, the bisamides are preferably in finely divided form and in particular have an average particle size of less than 50 μm. The maximum size of the particles is preferably below 20 μm, and at least 50%, in particular at least 75%, of the particles are smaller than 10 μm. These data relating to the particle size are based on the known determination method using the Coulter Counter.

The additional defoamer mixture mentioned can be prepared in such a way that the finely divided bisamide (component b) is introduced into a melt of the constituent (a) and homogenized therein by intensive mixing. For this purpose, the melt should have a temperature of at least 90° C. and at most 200° C. The temperature is preferably from 100 to 150° C. It is essential for good activity of this additional defoamer for a stable dispersion of the bisamide particles to be present in the paraffin matrix, which can be brought about by a particle size corresponding to the definition specified. For the purpose of achieving this state of dispersion, it is possible to use and disperse a bisamide which has the appropriate particle size from the outset, or a coarser-particle starting material is used and the melt is subjected to an intensive stirring treatment or a grinding treatment by means of colloid mills, toothed mills or ball mills until the desired particle size has been attained. Full melting of the bisamides in the paraffin melt and subsequent rapid cooling to temperatures below the solidification point of the bisamides with simultaneous homogenization of the melt can lead to a correspondingly fine particle distribution of the bisamides.

An inventive foam regulating composition can be prepared in a simple manner by spray-drying an aqueous composition of its ingredients or by applying the cellulose derivative, in liquid form or liquefied by heating or dissolution, if appropriate also the above-described molten additional defoamer mixture, onto the particulate support material, for example by successive admixing, in particular as a spray, to the support particle. The support particle, which can be obtained typically by spray-drying an aqueous slurry of the support salts, is kept in motion by mixer units or by fluidization in order to ensure uniform loading of the support material. The spray mixers used therefor can be operated continuously or batchwise. A particulate inventive foam regulating composition consists preferably of particles having particle sizes of not more than 2 mm, in particular from 0.1 mm to 1.6 mm. It preferably contains not more than 20% by weight, in particular not more than 5% by weight, of particles having a particle size of more than 1.6 mm, and not more than 20% by weight, in particular not more than 5% by weight, of particles having a particle size below 0.1 mm. The particulate foam regulating composition preferably has a bulk density in the range from 500 grams per liter to 1000 grams per liter. It is preferably used to produce particulate laundry detergents or cleaning compositions, a further advantage of the inventive foam regulating composition being noticeable in its low use amount for good defoamer performance.

Laundry detergents which comprise a cellulose derivative to be used in accordance with the invention may comprise all customary other constituents of such compositions. The cellulose derivative is incorporated into laundry detergents preferably in amounts of from 0.1% by weight to 5% by weight, in particular from 0.5% by weight to 2.5% by weight.

It has been found that, surprisingly, the cellulose derivative used in accordance with the invention positively influences the action of certain other laundry detergent and cleaning composition ingredients and that, conversely, the action of the cellulose derivative used in accordance with the invention is enhanced by certain other laundry detergent ingredients. These effects occur in particular in the case of active enzymatic ingredients, in particular proteases and lipases, in the case of water-insoluble inorganic builders, in the case of water-soluble inorganic and organic builders, in particular based on oxidized carbohydrates, in the case of peroxygen-based bleaches, in particular in the case of alkali metal percarbonates, in the case of synthetic sulfate- and sulfonate-type anionic surfactants and in the case of graying inhibitors, which is why preference is given to the use of at least one of the further ingredients mentioned together with the cellulose derivative to be used in accordance with the invention.

In a preferred embodiment, such a composition comprises nonionic surfactant selected from fatty alkyl polyglycosides, fatty alkyl polyalkoxylates, in particular ethoxylates and/or propoxylates, fatty acid polyhydroxy amides and/or ethoxylation and/or propoxylation products of fatty alkyl amines, vicinal diols, fatty acid alkyl esters and/or fatty acid amides and mixtures thereof, in particular in an amount in the range from 2% by weight to 25% by weight.

A further embodiment of such compositions includes the presence of synthetic sulfate- and/or sulfonate-type anionic surfactant, in particular fatty alkyl sulfate, fatty alkyl ether sulfate, sulfo fatty acid esters and/or sulfo fatty acid disalts, in particular in an amount in the range from 2% by weight to 25% by weight. The anionic surfactant is preferably selected from the alkyl or alkenyl sulfates or the alkyl or alkenyl ether sulfates, in which the alkyl or alkenyl group has from 8 to 22, in particular from 12 to 18, carbon atoms.

The useful nonionic surfactants include the alkoxylates, in particular the ethoxylates and/or propoxylates, of saturated or mono- or polyunsaturated linear or branched-chain alcohols having from 10 to 22 carbon atoms, preferably from 12 to 18 carbon atoms. The degree of alkoxylation of the alcohols is generally between 1 and 20, preferably between 3 and 10. They can be prepared in a known manner by reacting the appropriate alcohols with the appropriate alkylene oxides. Especially suitable are the derivatives of fatty alcohols, although they are branched-chain isomers, in particular what are known as oxo alcohols, can also be used to prepare usable alkoxylates. Accordingly usable are the alkoxylates, in particular the ethoxylates, of primary alcohols with linear radicals, especially dodecyl, tetradecyl, hexadecyl or octadecyl radicals, and mixtures thereof. Also usable are corresponding alkoxylation products of alkylamines, vicinal diols and carboxamides which correspond to the alcohols mentioned with regard to the alkyl moiety. Also useful are the ethylene oxide and/or propylene oxide insertion products of fatty acid alkyl esters, as can be prepared by the process specified in the international patent application WO 90/13533, and also fatty acid polyhydroxy amides, as can be prepared by the processes of the American patents U.S. Pat. No. 1,985,424, U.S. Pat. No. 2,016,962 and U.S. 2,703,798 and of the international patent application WO 92/06984. Alkylpolyglycosides which are suitable for incorporation into the inventive compositions are compounds of the general formula (G)ₙ-OR¹² in which R¹² is an alkyl or alkenyl radical having from 8 to 22 carbon atoms, G is a glycose unit and n is from 1 to 10. Such compounds and their preparation are described, for example, in the European patent applications EP 92 355, EP 301 298, EP 357 969 and EP 362 671, or the American patent U.S. Pat. No. 3,547,828. The glycoside component (G)n is oligo- or polymers composed of naturally occurring aldose or ketose monomers, which include in particular glucose, mannose, fructose, galactose, talose, gulose, altrose, allose, idose, ribose, arabinose, xylose and lyxose. The oligomers consisting of such glycosidically linked monomers are characterized, apart from by the type of sugars present therein, by the number thereof, known as the degree of oligomerization. The degree of oligomerization n, as a parameter to be determined analytically, generally assumes fractional numerical values; it is from 1 to 10, and below a value of 1.5 in the case of the glycosides used with preference, in particular between 1.2 and 1.4. Owing to the good availability, a preferred monomer unit is glucose. The alkyl or alkenyl moiety R¹² of the glycosides preferably likewise stems from readily obtainable derivatives of renewable raw materials, in particular from fatty alcohols, although the branched-chain isomers, in particular oxo alcohols, can also be used to prepare usable glycosides. Accordingly usable are in particular the primary alcohols having linear octyl, decyl, dodecyl, tetradecyl, hexadecyl or octadecyl radicals and mixtures thereof. Particularly preferred alkylglycosides contain a coconut fatty alkyl radical, i.e. mixtures having substantially R¹²=dodecyl and R¹²=tetradecyl.

Nonionic surfactant is present in compositions which comprise a cellulose derivative used in accordance with the invention preferably in amounts of from 1% by weight to 30% by weight, in particular from 1% by weight to 25% by weight, amounts in the upper part of this range being encountered mainly in liquid laundry detergents and particulate laundry detergents preferentially containing somewhat smaller amounts of up to 5% by weight. In a preferred embodiment, the nonionic surfactant is at least partly an alkoxylate, preferably an ethoxylate, of a branched-chain fatty alcohol such as isotridecanol.

Instead of this or in addition, the compositions may comprise further surfactants, preferably sulfate- or sulfonate-type synthetic anionic surfactants, for example alkylbenzenesulfonates, in amounts of preferably not more than 20% by weight, in particular from 0.1% by weight to 18% by weight, based in each case on overall composition. Synthetic anionic surfactants particularly suitable for use in such compositions are the alkyl and/or alkenyl sulfates having from 8 to 22 carbon atoms, which bear an alkali metal, ammonium or alkyl- or hydroxyalkyl-substituted ammonium ion as countercation. Preference is given to the derivatives of fatty alcohols having in particular from 12 to 18 carbon atoms and their branched-chain analogs, known as the oxo alcohols. The alkyl and alkenyl sulfates can be prepared in a known manner by reaction of the corresponding alcohol component with a customary sulfation reagent, in particular sulfur trioxide or chlorosulfonic acid, and subsequent neutralization with alkali metal, ammonium or alkyl- or hydroxyalkyl-substituted ammonium bases. Such alkyl and/or alkenyl sulfates are present in the compositions which comprise an inventive urethane-based polymer preferably in amounts of from 0.1% by weight to 15% by weight, in particular from 0.5% by weight to 10% by weight.

The usable sulfate-type surfactants also include the sulfated alkoxylation products of the alcohols mentioned, known as ether sulfates. Such ether sulfates contain preferably from 2 to 30, in particular from 4 to 10, ethylene glycol groups per molecule. The suitable sulfonate-type anionic surfactants include the a-sulfo esters obtainable by reaction of fatty acid esters with sulfur trioxide and subsequent neutralization, in particular the sulfonation products derived from fatty acids having from 8 to 22 carbon atoms, preferably from 12 to 18 carbon atoms, and linear alcohols having from 1 to 6 carbon atoms, preferably from 1 to 4 carbon atoms, and also the sulfo fatty acids arising from these by hydrolysis in a formal sense.

Useful further optional surfactant ingredients include soaps, suitable soaps being saturated fatty acid soaps such as the salts of lauric acid, myristic acid, palmitic acid or stearic acid, and also soaps derived from natural fatty acid mixtures, for example coconut, palm kernel or tallow fatty acids. In particular, preference is given to soap mixtures which are composed of from 50% by weight to 100% by weight of saturated C₁₂-C₁₈ fatty acid soaps and up to 50% by weight of oleic acid soap. Soap is present preferably in amounts of from 0.1% by weight to 5% by weight. Especially in liquid compositions which comprise a polymer used in accordance with the invention, higher amounts of soap of generally up to 20% by weight may, however, also be present.

If desired, the compositions may also comprise betaines and/or cationic surfactants which, if present, are used preferably in amounts of from 0.5% by weight to 7% by weight. Among these, the ester quats, i.e. quaternized esters of carboxylic acid and amino alcohol, are particularly preferred. These are known substances which can be obtained by the relevant methods of preparative organic chemistry. In this context, reference is made to the international patent application WO 91/01295, according to which triethanolamine is esterified partly with fatty acids in the presence of hypophosphorous acid, air is passed through and the mixture is subsequently quaternized with dimethyl sulfate or ethylene oxide. Moreover, the German patent DE 43 08 794 discloses a process for preparing solid ester quats in which the quaternization of triethanolamine esters is carried out in the presence of suitable dispersants, preferably fatty alcohols. Reviews on this theme have been published, for example, by R. Puchta et al. in Tens. Surf. Det., 30,186 (1993), M. Brock in Tens. Surf. Det. 30, 394 (1993), R. Lagerman et al. in J. Am. Oil.Chem. Soc., 71, 97 (1994) and I. Shapiro in Cosm. Toil. 109, 77 (1994).

In a further embodiment, a composition which comprises a cellulose derivative to be used in accordance with the invention comprises water-soluble and/or water-insoluble builders, in particularly selected from alkali metal aluminosilicate, crystalline alkali metal silicate having a modulus greater than 1, monomeric polycarboxylate, polymeric polycarboxylate and mixtures thereof, in particular in amounts in the range from 2.5% by weight to 60% by weight.

A composition which comprises a cellulose derivative to be used in accordance with the invention contains preferably from 20% by weight to 55% by weight of water-soluble and/or water-insoluble, organic and/or inorganic builders. The water-soluble organic builder substances include in particular those from the class of the polycarboxylic acids, in particular citric acid and sugar acids, and of the polymeric (poly)carboxylic acids, in particular the polycarboxylates obtainable by oxidation of polysaccharides of the international patent application WO 93/16110, polymeric acrylic acids, methacrylic acids, maleic acids and copolymers thereof, which may also contain small fractions of polymerizable substances without carboxylic acid functionality in copolymerized form. The relative molecular mass of the homopolymers of unsaturated carboxylic acids is generally between 5000 and 200 000, that of the copolymers between 2000 and 200 000, preferably from 50 000 to 120 000, based on the free acid. A particularly preferred acrylic acid-maleic acid copolymer has a relative molecular mass of from 50 000 to 100 000. Suitable, although less preferred, compounds of this class are copolymers of acrylic acid or methacrylic acid with vinyl ethers, such as vinyl methyl ether, vinyl esters, ethylene, propylene and styrene, in which the fraction of the acid is at least 50% by weight. The water-soluble organic builder substances used may also be terpolymers which contain, as monomers, two carboxylic acids and/or salts thereof and also, as a third monomer, vinyl alcohol and/or a vinyl alcohol derivative or a carbohydrate. The first acidic monomer or its salt derives from a monoethylenically unsaturated C₃-C₈-carboxylic acid and preferably from a C₃-C₄-monocarboxylic acid, in particular from (meth)acrylic acid. The second acidic monomer or its salt may be a derivative of a C₄-C₈-dicarboxylic acid, particular preference being given to maleic acid. The third monomeric unit is formed in this case by vinyl alcohol and/or preferably an esterified vinyl alcohol. Preference is given in particular to vinyl alcohol derivatives which constitute an ester of short-chain carboxylic acids, for example of C₁-C₄-carboxylic acids, with vinyl alcohols. Preferred terpolymers contain from 60% by weight to 95% by weight, in particular from 70% by weight to 90% by weight, of (meth)acrylic acid or (meth)acrylate, more preferably acrylic acid or acrylate, and maleic acid or maleate, and also from 5% by weight to 40% by weight, preferably from 10% by weight to 30% by weight, of vinyl alcohol and/or vinyl acetate. Very particular preference is given to terpolymers in which the weight ratio of (meth)acrylic acid or (meth)acrylate to maleic acid or maleate is between 1:1 and 4:1, preferably between 2:1 and 3:1 and in particular between 2:1 and 2.5:1. Both the amounts and the weight ratios are based on the acids. The second acidic monomer or its salt may also be a derivative of an allylsulfonic acid which is 2-substituted by an alkyl radical, preferably by a C₁-C₄-alkyl radical, or an aromatic radical which preferably derives from benzene or benzene derivatives. Preferred terpolymers contain from 40% by weight to 60% by weight, in particular from 45 to 55% by weight, of (meth)acrylic acid or (meth)acrylate, more preferably acrylic acid or acrylate, from 10% by weight to 30% by weight, preferably from 15% by weight to 25% by weight, of methallylsulfonic acid or methallylsulfonate, and, as a third monomer, from 15% by weight to 40% by weight, preferably from 20% by weight to 40% by weight, of a carbohydrate. This carbohydrate may be, for example, a mono-, di-, oligo- or polysaccharide, preference being given to mono-, di- or oligosaccharides, particular preference to sucrose. The use of the third monomer is presumed to incorporate intended breakage sites in the polymer, which are responsible for good biodegradability of the polymer. These terpolymers can be prepared in particular by processes which are described in the German patent DE 42 21 381 and the German patent application DE 43 00 772, and generally have a relative molecular mass between 1000 and 200 000, preferably between 200 and 50 000 and in particular between 3000 and 10 000. Especially for the preparation of liquid compositions, they may be used in the form of aqueous solutions, preferably in the form of 30 to 50 percent by weight aqueous solutions. All polycarboxylic acids mentioned are used generally in the form of their water-soluble salts, in particular their alkali metal salts.

Such organic builder substances are present preferably in amounts of up to 40% by weight, in particular up to 25% by weight and more preferably from 1% by weight to 5% by weight. Amounts close to the upper limit mentioned are used preferentially in pasty or liquid, in particular aqueous, compositions.

The water-insoluble, water-dispersible inorganic builder materials used are in particular crystalline or amorphous alkali metal aluminosilicates, in amounts of up to 50% by weight, preferably not more than 40% by weight, and in particular from 1% by weight to 5% by weight in liquid compositions. Among these, preference is given to the crystalline aluminosilicates in laundry detergent quality, in particular zeolite NaA and optionally NaX. Amounts close to the upper limit mentioned are used preferentially in solid, particulate compositions. Suitable aluminosilicates have in particular no particles having a particle size above 30 mm and consist preferably to an extent of at least 80% by weight of particles having a size below 10 mm. Their calcium binding capacity, which can be determined according to the specifications of the German patent DE 24 12 837, lies in the range from 100 to 200 mg of CaO per gram. Suitable substitutes or partial substitutes for the aluminosilicate mentioned are crystalline alkali metal silicates which may be present alone or in a mixture with amorphous silicates. The alkali metal silicates which can be used as builders in the compositions preferably have a molar ratio of alkali metal oxide to SiO₂ of below 0.95, in particular from 1:1.1 to 1:12, and may be present in amorphous or crystalline form. Preferred alkali metal silicates are the sodium silicates, in particular the amorphous sodium silicates, having a molar Na₂O:SiO₂ ratio of from 1:2 to 1:2.8. Such amorphous alkali metal silicates are commercially available, for example, under the name Portil®. Those having a molar Na₂O:SiO₂ ratio of from 1:1.9 to 1:2.8 can be prepared by the process of the European patent application EP 0 425 427. In the preparation, they are added preferably as a solid and not in the form of a solution. The crystalline silicates used, which may be present alone or in a mixture with amorphous silicates, are preferably crystalline sheet silicates of the general formula Na₂SiₓO₂ₓ₊₁.yH₂O, in which x, known as the modulus, is from 1.9 to 4 and y is from 0 to 20, and preferred values of x are 2, 3 or 4. Crystalline sheet silicates which fall under this general formula are described, for example, in the European patent application EP 0 164 514. Preferred crystalline sheet silicates are those in which x in the general formula mentioned assumes the value of 2 or 3. Preference is given in particular to both β- and δ-sodium disilicates (Na₂Si₂O₅.yH₂O), and β-sodium disilicate can be obtained, for example, by the process which is described in the international patent application WO 91/08171. δ-sodium silicates having a modulus between 1.9 and 3.2 can be prepared according to the Japanese patent applications JP 04/238 809 or JP 04/260 610. It is also possible to use virtually anhydrous crystalline alkali metal silicates which have been prepared from amorphous alkali metal silicates and are of the above-mentioned general formula in which x is from 1.9 to 2.1, preparable as described in the European patent applications EP 0 548 599, EP 0 502 325 and EP 0 425 428, in compositions which comprise a cellulose derivative used in accordance with the invention. In a further preferred embodiment of the composition, a crystalline sodium sheet silicate having a modulus of from 2 to 3 is used, as can be prepared from sand and sodium carbonate by the process of the European patent application EP 0 436 835. Crystalline sodium silicates having a modulus in the range from 1.9 to 3.5, as are obtainable by the processes of the European patent EP 0 164 552 and/or of the European patent application EP 0 294 753, are used in a further preferred embodiment of laundry detergents or cleaning compositions which comprise a cellulose derivative used in accordance with the invention. Their content of alkali metal silicates is preferably from 1% by weight to 50% by weight and in particular from 5% by weight to 35% by weight, based on anhydrous active substance. If alkali metal aluminosilicate, in particular zeolite, is present as an additional builder substance, the content of alkali metal silicate is preferably from 1% by weight to 15% by weight and in particular from 2% by weight to 8% by weight, based on anhydrous active substance. The weight ratio of aluminosilicate to silicate, based in each case on anhydrous active substances, is then preferably from 4:1 to 10:1. In compositions which comprise both amorphous and crystalline alkali metal silicates, the weight ratio of amorphous alkali metal silicate to crystalline alkali metal silicate is preferably from 1:2 to 2:1 and in particular from 1:1 to 2:1.

In addition to the inorganic builder mentioned, it is possible to use further water-soluble or water-insoluble inorganic substances in the compositions which comprise a cellulose derivative to be used in accordance with the invention. Suitable in this context are the alkali metal carbonates, alkali metal hydrogencarbonates and alkali metal sulfates, and also mixtures thereof. Such additional inorganic material may be present in amounts of up to 70% by weight.

In addition, the compositions may comprise further constituents customary in laundry detergents and cleaning compositions. These optional constituents include in particular enzymes, enzyme stabilizers, bleaches, bleach activators, complexing agents for heavy metals, for example aminopolycarboxylic acids, aminohydroxypolycarboxylic acids, polyphosphonic acids and/or aminopolyphosphonic acids, dye fixing active ingredients, dye transfer inhibitors, for example polyvinylpyrrolidone or polyvinylpyridine N-oxide, foam inhibitors, for example organopolysiloxanes or paraffins, solvents, and optical brighteners, for example stilbenedisulfonic acid derivatives. Compositions which comprise a cellulose derivative used in accordance with the invention preferably contain up to 1% by weight, in particular from 0.01% by weight to 0.5% by weight, of optical brighteners, in particular compounds from the class of the substituted 4,4′-bis(2,4,6-triamino-s-triazinyl)-stilbene-2,2′-disulfonic acids, up to 5% by weight, in particular from 0.1% by weight to 2% by weight, of complexing agents for heavy metals, in particular aminoalkylenephosphonic acids and salts thereof, up to 3% by weight, in particular from 0.5% by weight to 2% by weight, of graying inhibitors, and up to 2% by weight, in particular from 0.1% by weight to 1% by weight, of foam inhibitors, the proportions by weight specified being based in each case on overall composition.

Solvents which are used in particular in liquid compositions are, in addition to water, preferably those which are water-miscible. These include the lower alcohols, for example ethanol, propanol, isopropanol and the isomeric butanols, glycerol, lower glycols, for example ethylene glycol and propylene glycol, and the ethers which can be derived from the compound classes mentioned. In such liquid compositions, the cellulose derivatives used in accordance with the invention are generally in dissolved or suspended form.

Optionally present enzymes are preferably selected from the group comprising protease, amylase, lipase, cellulase, hemicellulase, oxidase, peroxidase or mixtures thereof. The primary useful enzyme is protease obtained from microorganisms such as bacteria or fungi. It can be obtained from suitable microorganisms in a known manner by fermentation processes, which are described, for example, in the German laid-open specifications DE 19 40 488, DE 20 44 161, DE 21 01 803 and DE 21 21 397, the American patents U.S. Pat. No. 3,623,957 and U.S. Pat. No. 4,264,738, the European patent EP 006 638 and the international patent application WO 91/02792. Proteases are commercially available, for example, under the names BLAP®, Savinase®, Esperase®, Maxatase®, Optimase®, Alcalase®, Durazym® or Maxapem®. The usable lipase can be obtained from Humicola lanuginosa, as described, for example, in the European patent applications EP 258 068, EP 305 216 and EP 341 947, from Bacillus species, as described, for example, in the international patent application WO 91/16422 or the European patent application EP 384 717, from Pseudomonas species, as described, for example, in the European patent applications EP 468 102, EP 385 401, EP 375 102, EP 334 462, EP 331 376, EP 330 641, EP 214 761, EP 218 272 or EP 204 284 or the international patent application WO 90/10695, from Fusarium species, as described, for example, in the European patent application EP 130 064, from Rhizopus species, as described, for example, in the European patent application EP 117 553 or from Aspergillus species, as described, for example, in the European patent application EP 167 309. Suitable lipases are commercially available, for example, under the names Lipolase®, Lipozym®, Lipomax®, Lipex®, Amano® lipase, Toyo-Jozo® lipase, Meito® lipase and Diosynth® lipase. Suitable amylases are commercially available, for example, under the names Maxamyl®, Termamyl®, Duramyl® and Purafect® OxAm. The usable cellulase may be an enzyme obtainable from bacteria or fungi which has a pH optimum preferably in the weakly acidic to weakly alkaline range of from 6 to 9.5. Such cellulases are known, for example, from the German laid-open specifications DE 31 17 250, DE 32 07 825, DE 32 07 847, DE 33 22 950 or the European patent applications EP 265 832, EP 269 977, EP 270 974, EP 273 125 and EP 339 550, and the international patent applications WO 95/02675 and WO 97/14804, and are commercially available under the names Celluzyme®, Carezyme® and Ecostone®.

The customary enzyme stabilizers optionally present, especially in liquid compositions, include amino alcohols, for example mono-, di-, triethanol- and -propanolamine and mixtures thereof, lower carboxylic acids, as known, for example, from the European patent applications EP 376 705 and EP 378 261, boric acid or alkali metal borates, boric acid-carboxylic acid combinations, as known, for example, from the European patent application EP 451 921, boric esters, as known, for example, from the international patent application WO 93/11215 or the European patent application EP 511 456, boronic acid derivatives, as known, for example, from the European patent application EP 583 536, calcium salts, for example the calcium-formic acid combination known from the European patent EP 28 865, magnesium salts, as known, for example, from the European patent application EP 378 262 and/or sulfur-containing reducing agents, as known, for example, from the European patent applications EP 080 748 or EP 080 223.

A further embodiment of such a composition which comprises a cellulose derivative to be used in accordance with the invention comprises peroxygen-based bleaches, in particular in amounts in the range from 5% by weight to 70% by weight, and also optionally bleach activator, in particular in amounts in the range from 2% by weight to 10% by weight. These useful bleaches are the per compounds used generally in laundry detergents, such as hydrogen peroxide, perborate which may be present as the tetra- or monohydrate, percarbonate, perpyrophosphate and persilicate, which are generally present as alkali metal salts, in particular as sodium salts. Such bleaches are present in laundry detergents which comprise a cellulose derivative to be used in accordance with the invention preferably in amounts of up to 25% by weight, in particular up to 15% by weight and more preferably from 5% by weight to 15% by weight, based in each case on overall composition, percarbonate in particular being used. The optionally present component of the bleach activators comprises the customarily used N- or O-acyl compounds, for example polyacylated alkylenediamines, in particular tetraacetylethylenediamine, acylated glycolurils, in particular tetraacetylglycoluril, N-acylated hydantoins, hydrazides, triazoles, urazoles, diketopiperazines, Attorney Docket No. H 06139 sulfurylamides and cyanurates, and also carboxylic anhydrides, in particular phthalic anhydride, carboxylic esters, in particular sodium isononanoylphenolsulfonate, and acylated sugar derivatives, in particular pentaacetylglucose, and also cationic nitrile derivatives such as trimethylammonioacetonitrile salts. To prevent interaction with the per compounds in the course of storage, the bleach activators may have been coated in a known manner with coating substances or granulated, in which case particular preference is given to tetraacetylethylenediamine which has been granulated with the aid of carboxymethylcellulose and has average particle sizes of from 0.01 mm to 0.8 mm, as can be prepared, for example, by the process described in the European patent EP 37 026, granulated 1,5-diacetyl-2,4-dioxohexahydro-1,3,5-triazine, as can be prepared by the process described in the German patent DD 255 884, and/or trialkylammonioacetonitrile formulated in particulate form by the processes described in the international patent applications WO 00/50553, WO 00/50556, WO 02/12425, WO 02/12426 or WO 02/26927. Laundry detergents comprise such bleach activators preferably in amounts of up to 8% by weight, in particular from 2% by weight to 6% by weight, based in each case on overall composition.

In a preferred embodiment, a composition into which the cellulose derivative to be used in accordance with the invention is incorporated is particulate and contains from 20% by weight to 55% by weight of inorganic builders, up to 10% by weight, in particular from 2% by weight to 8% by weight, of water-soluble organic builders, from 10% by weight to 25% by weight of synthetic anionic surfactant, from 1% by weight to 5% by weight of nonionic surfactant, up to 25% by weight, in particular from 5% by weight to 20% by weight, of bleach, in particular alkali metal percarbonate, up to 15% by weight, in particular from 1% by weight to 10% by weight, of bleach activator, and up to 25% by weight, in particular from 0.1% by weight to 25% by weight, of inorganic salts, in particular alkali metal carbonate and/or hydrogencarbonate.

In a further preferred embodiment, a composition into which the cellulose derivative to be used in accordance with the invention is incorporated is liquid and contains from 10% by weight to 25% by weight, in particular from 12% by weight to 22.5% by weight, of nonionic surfactant, from 2% by weight to 10% by weight, in particular from 2.5% by weight to 8% by weight, of synthetic anionic surfactant, from 3% by weight to 15% by weight, in particular from 4.5% by weight to 12.5% by weight, of soap, from 0.5% by weight to 5% by weight, in particular from 1% by weight to 4% by weight, of organic builders, in particular polycarboxylate such as citrate, up to 1.5% by weight, in particular from 0.1% by weight to 1% by weight, of complexing agents for heavy metals, such as phosphonate, and optionally enzyme, enzyme stabiliser, dye and/or fragrance, and also water and/or water-miscible solvent.

1. A method of reducing the foaming of cleaning compositions in liquid solutions, said method comprising the step of incorporating in the solution at least one cellulose derivative which is obtainable by alkylation and hydroxyalkylation of cellulose and which has an average of from 0.5 to 2.5 alkyl groups and from 0.02 to 0.5 hydroxyalkyl groups per anhydroglycose monomer unit.

2. The method as claimed in claim 1 wherein the cleaning composition is a laundry detergent.

3. The method as claimed in claim 1 wherein the cellulose derivative has been alkylated with C₁ to C₁₀ groups and has C₂ to C₁₀ hydroxyalkyl groups.

4. The method as claimed in claim 1 wherein the cellulose derivative has an average of from 1 to 2 alkyl groups and from 0.05 to 0.3 hydroxyalkyl groups per anhydroglycose monomer unit.

5. The method as claimed in claim 1 wherein the cellulose derivative has a mean molar mass of from 10,000 D to 150,000 D.

6. The method as claimed in claim 5 wherein the cellulose derivative has a mean molar mass of from 40,000 D to 120,000 D.

7. A method of reducing the foaming of liquid solutions comprising detergents during machine washing of textiles, said method comprising the step of incorporating at least one cellulose derivative which is obtainable by alkylation and hydroxyalkylation of cellulose.

8. The method as claimed in claim 7 wherein the cellulose derivative has an average of from 0.5 to 2.5 alkyl groups and from 0.02 to 0.5 hydroxyalkyl groups per anhydroglycose monomer unit and inhibits the formation of foam during the rinse cycle in the machine washing of the textiles.

9. The method as claimed in claim 7 wherein the cellulose derivative has been alkylated with C₁ to C₁₀ groups and has C₂ to C₁₀ hydroxyalkyl groups.

10. The method as claimed in claim 7 wherein the cellulose derivative has a mean molecular mass of from 10,000 D to 150,000 D.

11. A method of reducing the foaming of a liquid solution comprising a laundry detergent formed from at least one ingredient selected from the group consisting of active enzymatic ingredients, water-insoluble inorganic builders, water-soluble inortanic and organic builders, per-oxygen bleaches, non-ionic surfactants, synthetic sulfate- and sulfonate-type anionic surfactants, and graying inhibitors, the method comprising the step of incorporating in the detergent at least one cellulose derivative which is obtainable by alkylation and hydroxyalkylation of cellulose.

12. The method as claimed in claim 11 wherein the cellulose derivative has an average of from 0.5 to 2.5 alkyl groups and from 0.02 to 0.5 hydroxalkyl groups per anhydroglycose monomer unit.

13. The method as claimed in claim 11 wherein the cellulose derivative has been alkylated with C₁ to C₁₀ groups and has C₂ to C₁₀ hydroxyalkyl groups.

14. The method as claimed in claim 11 wherein the cellulose derivative has a mean molecular mass of from 10,000 D to 150,000 D.

15. A particulate free-flowing foam regulating composition containing from 0.5% by weight to 30% by weight of cellulose derivative which is obtainable by alkylation and hydroxyalkylation of cellulose, adsorbed on from 70% by weight to 99.5% by weight of a water-soluble or water-dispersible, inorganic and/or organic support material.

16. The particulate free-flowing foam regulating composition as claimed in claim 15 wherein the cellulose derivative has an average of from 0.5 to 2.5 alkyl groups and from 0.02 to 0.5 hydroxyalkyl groups per anhydroglycose monomer unit.

17. The particulate free-flowing foam regulating composition as claimed in claim 15 wherein the cellulose derivative has been alkylated with C₁ to C₁₀ groups and has C₂ to C₁₀ hydroxyalkyl groups.

18. The particulate free-flowing foam regulating composition as claimed in claim 15 wherein the cellulose derivative has an average of from 1 to 2 alkyl groups and from 0.05 to 0.3 hydroxyalkyl groups per anhydroglycose monomer unit.

19. The particulate free-flowing foam regulating composition as claimed in claim 15 wherein the cellulose derivative has a mean molar mass of from 10,000 D to 150,000 D.

20. The particulate free-flowing foam regulating composition as claimed in claim 15 wherein the cellulose derivative has a mean molar mass of from 80,000 D to 110,000 D.
